(19) United States
(12) Patent Application Publication
(10) Pub. No.: US 2025/0061037 A1
(43) Pub. Date: Feb. 20, 2025

(54) APPARATUS AND METHOD FOR PERFORMING PERFORMANCE ESTIMATION OF ARTIFICIAL INTELLIGENCE BASED MODEL CONSIDERING DEVICE CHARACTERISTICS

(71) Applicant: NOTA, INC., Daejeon (KR)

(72) Inventors: Junkyeong CHOI, Seoul (KR); Shinkook CHOI, Seoul (KR)

(21) Appl. No.: 18/762,238

(22) Filed: Jul. 2, 2024

(30) Foreign Application Priority Data
Aug. 16, 2023 (KR) 10-2023-0106800

(51) Int. Cl. G06F 11/34

(52) U.S. Cl. CPC G06F 11/3419

(57) ABSTRACT

According to an embodiment of the present disclosure, a method for providing estimated performance of an artificial intelligence (AI)-based model considering characteristic of a device, performed by a computing device, is disclosed. The method includes receiving at least one of an AI-based target model or target model information corresponding to the target model. The method includes receiving target device information corresponding to a target device. The method includes determining a target workload set including a plurality of workloads constituting the target model, based on at least one of the target model or the target model information. The method includes extracting a target performance predictor corresponding to the target device. The target performance predictor includes characteristic of the target device related to a workload. The method includes determining estimated performance when the target model is executed on the target device based on the target workload set and the target performance predictor.

### CROSS-REFERENCE TO RELATED APPLICATIONS

This application claims priority to and the benefit of Korean Patent Application No. 10-2023-0106800 filed in the Korean Intellectual Property Office on 16 Aug. 2023, the entire contents of which are incorporated herein by reference.

### BACKGROUND

### Technical Field

The present disclosure relates to artificial intelligence technologies and more specifically techniques for estimating performance of an artificial intelligence model considering characteristics of a device.

### Description of the Related Art

As the development of artificial intelligence technology, a variety of types of intelligence-based models have been developed. The demand for computational resources to handle various AI-based models is also increasing, and the development of hardware with new capabilities continues within related industries.

As the demand for edge technology or edge artificial intelligence technology that can perform direct calculations on a network terminal such as personal computers, smart phones, cars, wearable devices, and robots increase, the research and developments of AI-based models that take hardware resources into account are made.

As the importance of hardware increases in the field of artificial intelligence technology along with the development of edge technology, sufficient knowledge is required not only about the model itself but also about the various hardware on which artificial intelligence-based models will be executed. For example, even if there is a model with excellent performance in a specific domain, inference performance for these models can be different for each hardware where the model is to be executed. There can also be a situation in which a model having optimal performance is not supported in specific hardware in which a service is to be provided in a specific domain. Accordingly, in order to determine the artificial intelligence-based model suitable for the service to be provided and hardware suitable for the artificial intelligence-based model together, high levels of background knowledge and vast amounts of resources for the artificial intelligence technology and hardware technology can be required. US patent publication No. 2022-0121927 discloses providing neural networks for processing data in a plurality of hardware environments.

### BRIEF SUMMARY

The present disclosure has been made in an effort to efficiently provide an artificial intelligence-based model suitable for a specific device.

The present disclosure has been made in an effort to effectively and accurately estimate performance of an artificial intelligence model considering characteristics of a device.

Technical benefits of the present disclosure are not restricted to the technical benefits mentioned as above. Other unmentioned technical benefits will be apparently appreciated by those skilled in the art by referencing the following descriptions.

According to an embodiment of the present disclosure, a method for providing estimated performance of an artificial intelligence (AI)-based model considering characteristic of a device, performed by a computing device, is discloses. The method comprises: receiving at least one of an AI-based target model or target model information corresponding to the target model, and receiving target device information corresponding to a target device; determining a target workload set including a plurality of workloads constituting the target model, based on at least one of the target model or the target model information; extracting a target performance predictor corresponding to the target device, wherein the target performance predictor includes characteristic of the target device related to a workload; and determining estimated performance when the target model is executed on the target device based on the target workload set and the target performance predictor. Wherein the extracting the target performance predictor corresponding to the target device comprises: determining whether the characteristic of the target device is dependent on pre-stored characteristics of other devices; and when it is determined that the characteristic of the target device is dependent on the pre-stored characteristics of the other devices, generating the target performance predictor by using a combination of performance predictors corresponding to the other devices.

According to an embodiment of the present disclosure, the estimated performance includes latency information.

According to an embodiment of the present disclosure, each of the plurality of workloads is defined as an N-dimensional vector having N features that represent at least one of a function, an operation, or a structure of the target model, and N is a natural number.

According to an embodiment of the present disclosure, each of the plurality of workloads is determined based on at least one of a tilting parameter of a matrix multiplication, a connection relationship of an input and output tensors, an implementation mechanism of a deep learning runtime in which an operator is executed, an operator parameter, the number of MAC (Multiply-Accumulate) operations, an arithmetic intensity, a spatial size, the number of channels in a feature map and an operator type within the target model.

According to an embodiment of the present disclosure, the characteristic of the target device is determined based on changes in performance on the target device due to variations between workloads or variations in a feature of a workload.

According to an embodiment of the present disclosure, the characteristic of the target device is determined further based on a staircase performance characteristic, wherein the staircase performance characteristic is used to determine a start workload in variations between workloads.

According to an embodiment of the present disclosure, the characteristic of the target device is determined based on changes in performance on the target device due to variations between workloads, wherein the changes in performance on the target device include a first change in performance on the target device due to variations between a first set of workloads within pre-determined set of workloads, and a second change in performance on the target device due to variations between a second set of workloads within the pre-determined set of workloads, and wherein a first start workload corresponding to a start point of the first set of workloads and a second start workload corresponding to a start point of the second set of workloads are determined based on a staircase performance characteristic.

According to an embodiment of the present disclosure, the target performance predictor is a two-dimensional data structure that includes first data representing a workload and second data representing the characteristic of the target device.

According to an embodiment of the present disclosure, the extracting the target performance predictor corresponding to the target device comprises: extracting a plurality of sub-characteristics of the target device, based on measuring changes in performance of the target device between at least two workloads within a set of selected workloads multiple times across the set of selected workloads, wherein one sub-characteristic of the target device for at least two workloads is extracted by a single measurement; determining whether at least one of the plurality of sub-characteristics of the target device can be represented as a linear combination of pre-stored sub-characteristics of other devices; and generating the target performance predictor as a combination of performance predictors corresponding to the other devices, when it is determined that the at least one sub-characteristic of the target device can be represented as the linear combination of the pre-stored sub-characteristics of the other devices.

According to an embodiment of the present disclosure, second staircase characteristics of characteristics of the other devices have a multiple relationship or divisor relationship with a first staircase characteristic of characteristics of the target device.

According to an embodiment of the present disclosure, the performance predictors corresponding to the other devices are pre-stored in a performance predictor pool, wherein one performance predictor is mapped to one device in the performance predictor pool, and wherein the extracting the target performance predictor corresponding to the target device comprises, when it is determined that the sub-characteristic of the target device cannot be represented as the linear combination of the pre-stored sub-characteristics of the other devices, adding the target device or the sub-characteristic of the target device to the performance predictor pool.

According to an embodiment of the present disclosure, the target performance predictor includes a first characteristic of the target device, corresponding to each of workloads included in a set of pre-determined workloads, and a second characteristic of the target device, corresponding to each of workloads which are not included in the set of the pre-determined workloads, and wherein the second characteristic is extracted by applying linear interpolation to the first characteristic.

According to an embodiment of the present disclosure, the determining the estimated performance comprises determining the estimated performance when the target model is executed on the target device based on a sum of sub-estimated performances corresponding to the plurality of workloads included in the target workload set, wherein one workload corresponds to one sub-estimated performance and the sub-estimated performances are extracted from the target performance predictor.

According to an embodiment of the present disclosure, the determining the estimated performance comprises determining the estimated performance when the target model is executed on the target device by applying different estimated performance determination algorithms to each of the plurality of workloads included in the target workload set, based on whether the each of the plurality of workloads included in the target workload set is included in the target performance predictor.

According to an embodiment of the present disclosure, the determining the estimated performance comprises: identifying first workloads which are included in the target performance predictor among the plurality of workloads included in the target workload set and second workloads which are not included in the target performance predictor among the plurality of workloads included in the target workload set; extracting first sub-estimated performances corresponding to the first workloads from the target performance predictor, and determining second sub-estimated performances corresponding to the second workloads based on first sub-estimated performances corresponding to the first workloads; and determining the estimated performance when the target model is executed on the target device based at least partially on the first sub-estimated performances and the second sub-estimated performances.

According to an embodiment of the present disclosure, the determining the second sub-estimated performances comprises determining second sub-estimated performances corresponding to the second workloads by using a linear slope between first sub-estimated performances corresponding to the first workloads related to the second workloads.

According to an embodiment of the present disclosure, the determining the second sub-estimated performances uses at least one of a linear interpolation or a linear extrapolation.

According to an embodiment of the present disclosure, a computer program stored in a non-transitory computer readable storage medium is disclosed. The computer program allows a computing device to perform following operations to provide estimated performance of an artificial intelligence (AI)-based model considering characteristic of a device. The operations comprise: receiving at least one of an AI-based target model or target model information corresponding to the target model, and receiving target device information corresponding to a target device; determining a target workload set including a plurality of workloads constituting the target model, based on at least one of the target model or the target model information; extracting a target performance predictor corresponding to the target device, wherein the target performance predictor includes characteristic of the target device related to a workload; and determining estimated performance when the target model is executed on the target device based on the target workload set and the target performance predictor. Wherein the extracting the target performance predictor corresponding to the target device comprises: determining whether the characteristic of the target device is dependent on pre-stored characteristics of other devices; and when it is determined that the characteristic of the target device is dependent on the pre-stored characteristics of the other devices, generating the target performance predictor by using a combination of performance predictors corresponding to the other devices.

According to an embodiment of the present disclosure, a computing device for providing estimated performance of an artificial intelligence (AI)-based model considering characteristic of a device, comprising at least one processor and a memory, is disclosed. The at least one processor: receives at least one of an AI-based target model or target model information corresponding to the target model, and receives target device information corresponding to a target device; determines a target workload set including a plurality of workloads constituting the target model, based on at least one of the target model or the target model information; extracts a target performance predictor corresponding to the target device, wherein the target performance predictor includes characteristic of the target device related to a workload; and determines estimated performance when the target model is executed on the target device based on the target workload set and the target performance predictor. Wherein the extracting the target performance predictor corresponding to the target device comprises: determining whether the characteristic of the target device is dependent on pre-stored characteristics of other devices; and when it is determined that the characteristic of the target device is dependent on the pre-stored characteristics of the other devices, generating the target performance predictor by using a combination of performance predictors corresponding to the other devices.

The technique aspect according to an exemplary embodiment of the present disclosure can efficiently and accurately provide or generate an artificial intelligence-based model suitable for a specific device.

The technique aspect according to an exemplary embodiment of the present disclosure can effectively and accurately predict performance of an artificial intelligence model while considering characteristics of a device.

### BRIEF DESCRIPTION OF THE SEVERAL VIEWS OF THE DRAWINGS

FIG. 1 schematically illustrates a block diagram of a computing device according to an embodiment of the present disclosure.

FIG. 2 illustrates an exemplary structure of an artificial intelligence-based model according to an exemplary embodiment of the present disclosure.

FIG. 3 exemplarily illustrates a method for providing a predicted performance of an artificial intelligence model considering device characteristics according to an exemplary embodiment of the present disclosure.

FIG. 4 exemplarily illustrates a method for providing a predicted performance of an artificial intelligence model considering device characteristics according to an exemplary embodiment of the present disclosure.

FIG. 5 exemplarily illustrates a relationship between a workload and a performance of a target device and a target model according to an exemplary embodiment of the present disclosure.

FIG. 6 exemplarily illustrates a methodology for interpolating the relationship between a workload and a performance of a target device and a target model according to an exemplary embodiment of the present disclosure.

FIG. 7 exemplarily illustrates a methodology for generating a performance predictor for a target device according to an exemplary embodiment of the present disclosure.

FIG. 8 is an exemplary schematic view of an exemplary computing environment of a computing device in which the exemplary embodiments of the present disclosure may be implemented.

### DETAILED DESCRIPTION

Various exemplary embodiments will be described with reference to drawings. In the specification, various descriptions are presented to provide appreciation of the present disclosure. Prior to describing detailed contents for carrying out the present disclosure, it should be noted that configurations not directly associated with the technical gist of the present disclosure are omitted without departing from the technical gist of the present disclosure. Further, terms or words used in this specification and claims should be interpreted as meanings and concepts which match the technical spirit of the present disclosure based on a principle in which the inventor can define appropriate concepts of the terms in order to describe his/her disclosure by a best method.

“Module,” “system,” “model” and the like which are terms used in the specification refer to a computer-related entity, hardware, firmware, software, and a combination of the software and the hardware, or execution of the software, and interchangeably used. For example, the module may be a processing procedure executed on a processor, the processor, an object, an execution thread, a program, application and/or a computing device, but is not limited thereto. One or more modules may reside within the processor and/or a thread of execution. The module may be localized in one computer. One module may be distributed between two or more computers. Further, the modules may be executed by various computer-readable media having various data structures, which are stored therein. The modules may perform communication through local and/or remote processing according to a signal (for example, data from one component that interacts with other components and/or data from other systems transmitted through a network such as the Internet through a signal in a local system and a distribution system) having one or more data packets, for example.

Moreover, the term “or” is intended to mean not exclusive “or” but inclusive “or.” That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” and “at least one” used in this specification designates and includes all available combinations of one or more items among enumerated related items. For example, the term “at least one of A or B” or “at least one of A and B” should be interpreted to mean “a case including only A,” “a case including only B,” and “a case in which A and B are combined.”

Further, it should be appreciated that the term “comprise/include” and/or “comprising/including” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

Those skilled in the art need to recognize that various illustrative logical components, blocks, modules, circuits, means, logics, and algorithms described in connection with the exemplary embodiments disclosed herein may be additionally implemented as electronic hardware, computer software, or combinations of both sides. To clearly illustrate the interchangeability of hardware and software, various illustrative components, blocks, means, logics, modules, circuits, and steps have been described above generally in terms of their functionalities. Whether the functionalities are implemented as the hardware or software depends on a specific application and design restrictions given to an entire computing device.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, terms represented by N-th such as first, second, or third are used for distinguishing at least one entity. For example, entities expressed as first and second may be the same as each other or different from each other.

The term “model” used in the present disclosure may be used as a meaning that encompasses the artificial intelligence based model, the artificial intelligence model, the computation model, the neural network, a network function, and the neural network. In an exemplary embodiment, the model or model information may mean a model file, identification information of the model, an execution configuration of the model, and/or a framework of the model.

A term “target model” used in the present disclosure may include an artificial intelligence based model which becomes a target of performance measurement. Further, the “target model” may include an artificial intelligence based model which becomes a target of performance prediction. The technique according to an exemplary embodiment of the present disclosure may obtain an estimated performance (e.g., latency information, etc.) when a target model is executed in a target device by a resource efficient scheme.

The term “device” used in the present disclosure may correspond to hardware in which the model is to be executed or hardware identification information. In an additional example, the device may correspond to hardware in which benchmarking of the model is to be performed or hardware identification information. The hardware may be used as a meaning that encompasses physical hardware, virtual hardware, hardware which is impossible to be accessed through the network from the outside, hardware which is impossible to confirm externally, and/or hardware which is confirmed in a cloud. For example, the device information in the present disclosure may include various types of hardware such as Jetson Nano, Jetson Xavier NX, Jetson TX2, Jetson AGX Xavier, Jetson AGX Orin, GPU AWS-T4, Xeon-W-2223, Raspberry Pi Zero, Raspberry Pi 2W, Raspberry Pi 3B+, AVH and/or Raspberry Pi Zero 4B.

The term “target device” used in the present disclosure may correspond to hardware which becomes a target of performance measurement and/or performance prediction, or hardware identification information.

A term “workload” used in the present disclosure may correspond to a component constituting the model. As an example, the workload may include an object or a set of objects constituting the model. As another example, the workload may include a resource or a group of resources included in the model. As another example, the workload may include qualitative information related to an operation of the model and/or quantitative information related to the operation of the model. For example, the workload may be expressed as a feature related to a function, an operation, and/or a structure of the model. For example, the workload may be defined as an N-dimensional vector having N features. For example, the workload may include an operator, a residual block, and/or a building block of the model. The workload may be used interchangeably with a workload value. For example, a change of the workload may mean a change of the workload value. The change of the workload may mean a change of the workload value according to a change of the feature included in the workload. For example, as values of features included in the workload are changed, a workload (or workload value) corresponding to the N-dimensional vector may be changed.

In an exemplary embodiment, the feature of the workload as a component constituting the workload may include, for example, an operator type, the number of channels of an input feature map, the number of channels of an output feature map, a spatial size, an arithmetic intensity, the number of MAC operations, an operator parameter, an implementation scheme of a deep learning runtime in which the operator is driven, a connection relationship of input and output tensors of the operator, and/or a tilting parameter of a matrix multiplication.

As an example, the operator parameter may include the number of channels and a spatial size of the feature map, a kernel size indicating a size of a convolutional filter, a stride providing sparse of a convolutional operation, and/or padding of adjusting a size of the feature map.

As an example, the deep learning runtime in which the operator is driven may include a parameter related to optimization of an artificial intelligence based model. For example, in the case of the convolutional operator, as a technique of im2col is used, a technique of direct convolution is used, and/or a technique of Winograd convolution is used, a memory usage and/or latency may be different. The workload feature corresponding to the deep learning runtime in which the operator is driven may include a scheme of determining or implementing an actual implementation scheme of the operator or an optimization scheme of the operator.

As an example, tensors may be input and output according to the connection relationship of the operators of the artificial intelligence based model. For example, the same convolutional layer may have a different input and/or output relationship according to an implementation aspect. Accordingly, the memory usage and/or latency may be different in spite of the same operator according to the connection relationship of the input and output tensors of the operator. The connection relationship of the input and output tensors of the operator according to an exemplary embodiment of the present disclosure may correspond to a workload feature for representing the connection relationship related to the input and the output of the operator.

The term “benchmark” used in the present disclosure may mean an operation of executing or testing the model in the device, an operation of measuring the performance for the device of the model, and/or an operation of predicting the performance of the device of the model. A benchmark result or benchmark result information in the present disclosure may include information obtained according to the benchmark or information obtained by processing the information obtained according to the benchmark. In the present disclosure, a benchmark prediction result or benchmark prediction result information may mean a benchmark result predicted when the model is executed in the device. For example, the benchmark prediction result may correspond to a benchmark result obtained without executing the model in the device (that is, without measuring the performance).

In an additional exemplary embodiment of the present disclosure, the workload may correspond to the operator. The operator may be used to mean the component constituting the model. For example, one model may include a plurality of operators. For example, the plurality of operators may be connected to each other through an edge. An operation of the model may be performed through operations of the plurality of operators. For example, the operator may be used interchangeably with a node or layer of the model. As an example, a convolutional layer may become an example for the operator in the artificial intelligence model.

A term “performance predictor” used in the present disclosure may represent device characteristics for the workload. For example, the performance predictor may mean a set for device characteristics corresponding to each of a plurality of workloads. For example, one performance predictor may correspond to one device. When a performance predictor corresponding to a specific device is prepared, as a workload for an input model is determined, an estimated performance when the model is executed in the device may be determined.

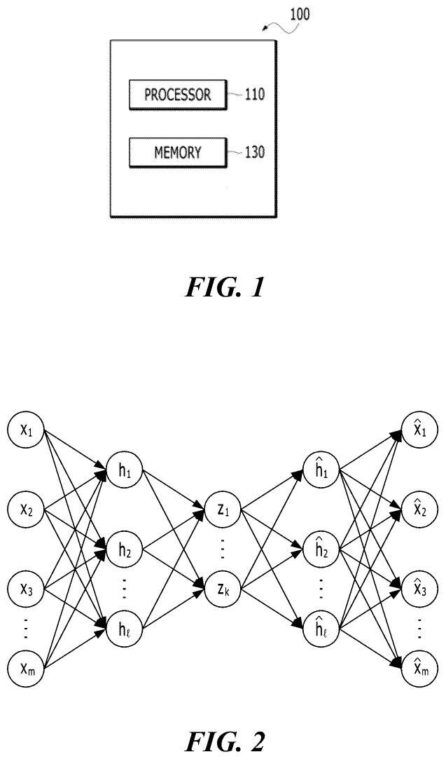

FIG. 1 schematically illustrates a block diagram of a computing device 100 according to an exemplary embodiment of the present disclosure.

According to the exemplary embodiment of the present disclosure, a computing device 100 may include a processor 110 and a memory 130.

A configuration of the computing device 100 illustrated in FIG. 1 is only an example shown through simplification. In an exemplary embodiment of the present disclosure, the computing device 100 may include other components for performing a computing environment of the computing device 100, and only some of the disclosed components may also constitute the computing device 100.

The computing device 100 in the present disclosure may be used as a meaning that encompasses any type of server and any type of terminal.

In the present disclosure, the computing device 100 may mean any type of component constituting a system for implementing exemplary embodiments of the present disclosure.

The components of the computing device 100 illustrated in FIG. 1 may be exemplary and some components may be excluded, or an additional component may be included in the computing device 100. As an example, when the computing device 100 includes a user terminal, an output unit (not illustrated) and an input unit (not illustrated) may be included in a scope of the computing device 100.

In an exemplary embodiment, the computing device 100 may mean a device that provides an estimated performance for a model based on device recognition.

In an exemplary embodiment, the computing device 100 may mean a device that measures, estimates, manages and/or stores performances of one or more devices of an artificial intelligence-based model in communication with one or more devices. For example, the computing device 100 may refer to a device for managing a device farm. In another example, the computing device 100 may also correspond to the device farm.

In another exemplary embodiment, the computing device 100 may mean a device that generates the learning model through modeling for an input dataset, generates a lightweight model through compression for an input model, and/or generates download data so as to deploy the input model in a specific device. In the exemplary embodiment, the computing device 100 may be configured to include the device farm.

In the present disclosure, deploy or deployment may mean any type of activity which enables software (e.g., model) to be used. For example, the deploy or deployment may be interpreted as an overall process customized according to specific requirements or characteristics of the model or node. An example of the deploy or deployment may include release, installation and activation, deactivation, removal, update, built-in update, adaptation, and/or version tracking.

In an additional exemplary embodiment of the present disclosure, the computing device 100 may transform the input model so that the input model is compatible with the specific device. The computing device 100 may also generate a result of converting the model or obtain the converted result from another computing device or an external entity (e.g., a converting device).

In an exemplary embodiment, the processor 110 may be constituted by at least one core and may include processors for data analysis and/or processing, such as a central processing unit (CPU), a general purpose graphics processing unit (GPGPU), a tensor processing unit (TPU), and the like of the computing device 100.

The processor 110 may read a computer program stored in the memory 130 to provide the estimated performance for the target model according to an exemplary embodiment of the present disclosure.

According to an exemplary embodiment of the present disclosure, the processor 110 may also perform a computation for learning a neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of the plurality of computing devices may be used together to process the learning of the network function and the data classification using the network function. Further, the computer program executed in the computing device 100 according to an exemplary embodiment of the present disclosure may be a CPU, GPGPU, or TPU executable program.

Additionally, the processor 110 may generally process an overall operation of the computing device 100. For example, the processor 110 processes data, information, signals, and the like input or output through the components included in the computing device 100 or drives the application program stored in a storage unit to provide information or a function appropriate for the user.

According to an exemplary embodiment of the present disclosure, the memory 130 may store any type of information generated or determined by the processor 110 or any type of information received by the computing device 100. According to an exemplary embodiment of the present disclosure, the memory 130 may be a storage medium that stores computer software which allows the processor 110 to perform the operations according to the exemplary embodiments of the present disclosure. Therefore, the memory 130 may mean computer-readable media for storing software codes required for performing the exemplary embodiments of the present disclosure, data which become execution targets of the codes, and execution results of the codes.

According to an exemplary embodiment of the present disclosure, the memory 130 may mean any type of storage medium, and include, for example, at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the memory 130 used in the present disclosure is not limited to the examples.

In the present disclosure, the communication unit (not illustrated) may be configured regardless of communication modes such as wired and wireless modes and constituted by various communication networks including a personal area network (PAN), a wide area network (WAN), and the like. Further, the network unit 150 may operate based on known World Wide Web (WWW) and may adopt a wireless transmission technology used for short-distance communication, such as infrared data association (IrDA) or Bluetooth.

The computing device 100 in the present disclosure may include any type of user terminal and/or any type of server. Therefore, the exemplary embodiments of the present disclosure may be performed by the server and/or the user terminal.

In an exemplary embodiment, the user terminal may include any type of terminal which is capable of interacting with the server or another computing device. The user terminal may include, for example, a mobile phone, a smart phone, a laptop computer, personal digital assistants (PDA), a slate PC, a tablet PC, and an Ultrabook.

In an exemplary embodiment, the server may include, for example, any type of computing system or computing device such as a microprocessor, a mainframe computer, a digital processor, a portable device, and a device controller.

In an exemplary embodiment, the server may store and manage characteristics of a device, a performance predictor of the device, a set of workloads for determining the characteristics of the device, staircase performance characteristics of the device, a performance prediction result, a benchmark prediction result, and/or performance information of devices. For example, the server may include a memory 30 for storing the information. The memory 130 may be included in the server, or may be present under the management of the server. As another example, the memory 130 may also be present outside the server, and implemented in a form which is capable of communicating with the server. In this case, the memory 130 may be managed and controlled by another external server different from the server. As another example, the memory 130 may also be present outside the server, and implemented in a form which is capable of communicating with the server. In this case, the memory 130 may be managed and controlled by another external server different from the server.

FIG. 2 illustrates an illustrative structure of an artificial intelligence-based model according to an exemplary embodiment of the present disclosure.

Throughout the present disclosure, the model, the artificial intelligence model, the artificial intelligence-based model, the operation model, and the neural network, the network function, and the neural network may be used interchangeably.

The artificial intelligence-based model in the present disclosure may include models which are utilizable in various domains, such as a model for image processing such as object segmentation, object detection, and/or object classification, a model for text processing such as data prediction, text semantic inference and/or data classification, etc.

The neural network may be generally constituted by an aggregate of calculation units which are mutually connected to each other, which may be called “node.” The nodes may also be called neurons. The neural network is configured to include one or more nodes. The nodes (or neurons) constituting the neural networks may be mutually connected to each other by one or more links.

The node in the artificial intelligence-based model may be used to mean a component that constitutes the neural network, and for example, the node in the neural network may correspond to the neuron.

In the neural network, one or more nodes connected through the link may relatively form a relationship between an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed from the initial input node up to the corresponding node. However, definition of the layer is predetermined for description and the order of the layer in the neural network may be defined by a method different from the aforementioned method. For example, the layers of the nodes may be defined by the distance from a final output node.

In an exemplary embodiment of the present disclosure, the set of the neurons or the nodes may be defined as the expression “layer.”

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

The deep neural network (DNN) may mean a neural network including a plurality of hidden layers other than the input layer and the output layer. When the deep neural network is used, the latent structures of data may be identified. That is, photographs, text, video, voice, protein sequence structure, genetic sequence structure, peptide sequence structure, and/or potential structure of music (e.g., what objects are in the photo, what is the content and emotions of the text, what contents and emotions of the voice, etc.) may be identified. The deep neural network may include convolutional neural network (CNN), recurrent neural network (RNN), auto encoder, generative adversarial networks (GAN), restricted Boltzmann machine (RBM), deep belief network (DBN), Q network, U network, Siamese network, etc. The description of the deep neural network described above is just an example and the present disclosure is not limited thereto.

The artificial intelligence-based model of the present disclosure may be expressed by a network structure of an arbitrary structure described above, including the input layer, the hidden layer, and the output layer.

The neural network which may be used in a clustering model in the present disclosure may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to an exemplary embodiment of the present disclosure, a computer readable medium is disclosed, which stores a data structure including estimated performance, the benchmark result and/or the artificial intelligence model. The data structure may be stored in a storage unit (not illustrated) in the present disclosure, and executed by the processor 110 and transmitted and received by a communication unit (not illustrated).

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node.” The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example, and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable, and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example, and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example, and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example, and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

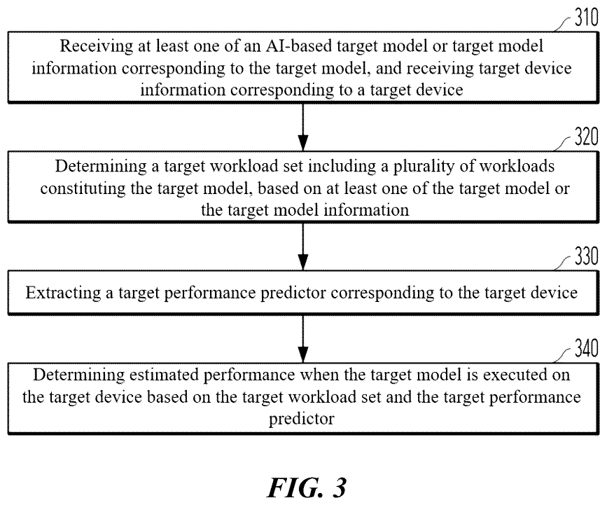

FIG. 3 exemplarily illustrates a method for providing an estimated performance of an artificial intelligence-based model considering device characteristics according to an exemplary embodiment of the present disclosure.

As illustrated in FIG. 3, the computing device 100 may extract at least one of an artificial intelligence target model or target model information corresponding to the target model, and extract target device information corresponding to a target device (310).

In an exemplary embodiment, the artificial intelligence target model or the target model information may include any type of information for identifying an artificial intelligence model. For example, the target model may include a model file corresponding to the target model. For example, the target model may include a dataset prepared for training the target model. For example, the target model information may include identification information of the target model and/or model file information corresponding to the target model. For example, the target model information as any type of information for identifying the target model may include information indicating an execution configuration of the model, such as Tflite, Onnxruntime, OpenVINO, and TensorRT. For example, the target model information may also include library information or software version information for an execution configuration of the target model. In such an example, the target model information may be expressed as Python 3.7.3 and pillow 5.4.1 of Tflite.

In an exemplary embodiment, the target model and/or the target model information may be obtained by an input from a user. For example, the input from the user may include a selection input of selecting a specific model identifier and/or an upload input of uploading a model file among a plurality of selections. In an additional example, the target model information may include identification information of a model, a name of a model file, an extension of the model file, the model file itself, a software version, a framework, a size of the model, an input shape of the model, a batch size, and/or the number of channels.

In an exemplary embodiment, the computing device 100 may extract the target device information input from the user. For example, the target device information may include any type of information identifying a device in which the target model is to be executed. For example, the target device information may include identification information of the target device, information for describing characteristics, a memory capacity, processor information, and/or performance information of the target device, and/or manufacturer information of the target device. As a non-limiting example, the target device information may include Jetson Nano, Jetson Xavier NX, Jetson TX2, Jetson AGX Xavier, Jetson AGX Orin, GPU AWS-T4, Xeon-W-2223, Raspberry Pi Zero, AVH, Raspberry Pi 2W, Raspberry Pi 3B+, and/or Raspberry Pi Zero 4B.

The target device in the present disclosure may be used to refer to a device in which the target model is to be executed, a device in which performance of the target model is to be measured, or a device in which performance of the target model is to be predicted. For example, the target device may correspond to an embedded device on which the target model is to be driven. For example, the target device may be determined by a user input.

Additionally, a condition for selecting the target device may be obtained from the user input. The computing device 100 may determine a plurality of candidate target devices that meet the condition based on the user input. The computing device 100 may determine a target device based on an additional user input on a candidate target device.

In an exemplary embodiment, the computing device 100 may determine a target workload set including a plurality of workloads constituting the target model based on at least one of the target model or the target model information (320).

In an exemplary embodiment, the workload may represent a work corresponding to a split unit in a deep learning network. The workload may be used to measure device characteristics. As an example, the workload may be defined as an N-dimensional vector having N features. Here, N may correspond to a natural number. A workload feature corresponding to a component of each vector may correspond to a component constituting the workload.

In an exemplary embodiment, each of the plurality of workloads may be determined based on at least one of an operator type, the number of channels and a spatial size of a feature map, an arithmetic intensity, the number of MAC operations, an operator parameter, an implementation scheme of a deep learning runtime in which the operator is driven, a connection relationship of input and output tensors of the operator, and/or a tilting parameter of a matrix multiplication.

In an exemplary embodiment, the computing device 100 may obtain a plurality of workloads constituting the target model. Different workloads may be determined according to an operation, a structure, and/or a function of the target model. For example, the computing device 100 may extract a target workload set including workloads constituting the target model on a workload table corresponding to the target model.

For example, the computing device 100 may determine operators constituting the target model. The computing device 100 analyzes operations, functions, and/or structures for the respective operators to obtain workloads corresponding to the operators, respectively. In such an example, the sum of the workloads corresponding to the operators included in the target model may be referred to as a target workload set for the target model. In such an example, the computing device 100 performs parsing for the model file to obtain the operators constituting the target model. For example, it is assumed that the target model is constituted by a first operator that performs a first convolutional operation, a second operator that performs a sigmoid operation, a third operator that performs a second convolutional operation, and a fourth operator that performs an Add operation. The computing device 100 may obtain the first operator, the second operator, the third operator, and the fourth operator by parsing the target model. In an exemplary embodiment, the computing device 100 may determine the workloads corresponding to the obtained operators, respectively, based on a mapping table between the operator and the workload corresponding to the obtained operators. The computing device 100 may determine the workloads corresponding to the obtained operators, respectively, as the target workload set.

In an additional exemplary embodiment, the computing device 100 may obtain the target workload set corresponding to the target model by using a pre-trained model that inputs components and/or characteristics of the target model, and outputs the workload constituting the target model. In such an exemplary embodiment, the pre-trained model may correspond to a model pre-trained to output at least one workload feature which may constitute the workload of the target model by receiving various types of input data related to the target model. The computing device 100 may determine the workload corresponding to the target model by using the workload features from the pre-trained model. For example, the pre-trained model may output a plurality of features corresponding to the first operator from an input (e.g., the number of channels, a value of a kernel, and/or a padding value) related to the first operator that performs the first convolutional operation of the target model. The plurality of features may be determined as the workload corresponding to the first operator. The computing device 100 determines workloads for a plurality of operators constituting the target model, respectively, to obtain the target workload set corresponding to the target model.

In an exemplary embodiment of the present disclosure, the workload may be determined based on, for example, an operator type, the number of channels of an input feature map, the number of channels of an output feature map, a spatial size, an arithmetic intensity, the number of MAC operations, an operator parameter, an implementation scheme of a deep learning runtime in which the operator is driven, a connection relationship of input and output tensors of the operator, and/or a tilting parameter of a matrix multiplication.

In an exemplary embodiment, the computing device 100 may obtain a target performance predictor corresponding to the target device (330).

In an exemplary embodiment, the target performance predictor may be defined as characteristics of the target device for the workloads, respectively.

In an exemplary embodiment, mapping between the performance predictor and the device may be pre-stored. Characteristics (e.g., the performance of a device) for a plurality of respective devices may be determined by using a set of selected (or predetermined) workloads. For example, the characteristics for the plurality of respective devices and the selected (or predetermined) workloads are expressed in two dimensions to generate the performance predictor corresponding to each of the plurality of devices. For example, the computing device 100 may determine whether the performance predictor corresponding to the target device is pre-stored. When it is determined that the performance predictor corresponding to the target device is pre-stored, the computing device 100 may obtain a target performance predictor corresponding to the target device through pre-stored information.

In an exemplary embodiment, when the target device is a new device, and/or when the target performance predictor corresponding to the target device is not pre-stored, the computing device 100 may determine characteristics of the target device, and determine whether the characteristics of the target device may be generated by a combination of (pre-stored) characteristics of other devices. When the computing device 100 determines that the characteristics of the target device may be generated through the combination of the characteristics of other devices, the computing device 100 may generate the target performance predictor by combining performance predictors corresponding to other devices. As a result, when the new device is input, the target performance predictor for generating an estimated performance related to the target device may be generated by a resource efficient scheme.

In an exemplary embodiment, the target performance predictor may be generated or obtained based on the characteristics of the target device. In an exemplary embodiment, the characteristics of the target device may be determined based on a change in performance on the target device according to a change in workload. The characteristics of the target device may be determined additionally based on staircase performance characteristics of the target device, and here, the staircase performance characteristics may be used to determine a start workload of the workload change. In an exemplary embodiment, the characteristics of the target device may be determined based on a performance change of the target device according to the workload change, and here, the performance change of the target device may include a first performance change of the target device according to a change between a first set of workloads in the set of selected (or predetermined) workloads and a second performance change of the target device according to a change between a second set of workloads in the set of selected (or predetermined) workloads. In an exemplary embodiment, a first start workload corresponding to a start point of the first set of workloads and a second start workload corresponding to a start point of the second set of workloads may be determined based on the staircase performance characteristics of the target device.

In an exemplary embodiment, the computing device 100 may obtain the set of selected (or predetermined) workloads in order to determine the characteristics of the target device. The set of selected (or predetermined) workloads may correspond to a set of characteristics corresponding to other devices, respectively, and workloads used for generating the performance predictor. The computing device 100 may obtain or measure a first performance of a target device for a first workload and a second performance of the target device for a second workload in the set of selected (or predetermined) workloads. The computing device 100 may determine the characteristics of the target device by using a difference between the first performance and the second performance. In an exemplary embodiment, the computing device 100 may calculate a latency change rate on the target device for a change of a workload feature (or a vector of the workload feature) in the set of selected (or predetermined) workloads. The latency change rate may be expressed as an N-dimensional vector for a feature dimension. It may be confirmed how a latency reacts or changes according to a change in feature dimension of each workload through the N-dimensional vector. As such, the computing device 100 analyzes a change in performance of the target device according to the change in workload or the change in workload feature to obtain slope characteristics of the target device corresponding to the change in workload.

In an exemplary embodiment, the computing device 100 may obtain subsets of N (N is a natural number) workloads acquired by splitting the set of selected (or predetermined) workloads randomly or evenly. The latency change rate of the target device for the change in workload or the change in change of the workload feature in the subsets of the workloads may also be calculated.

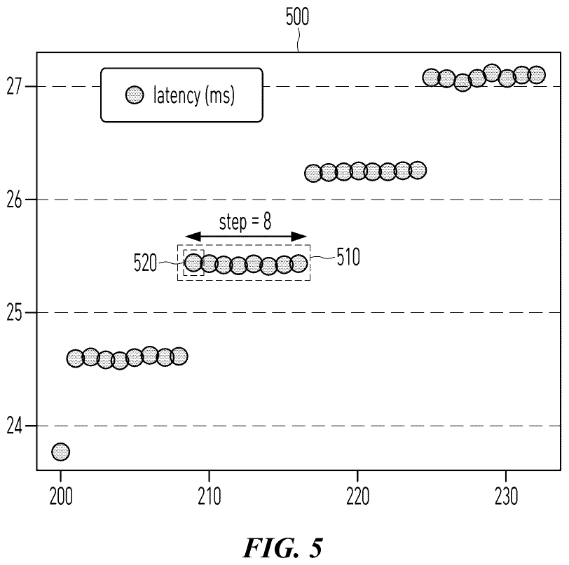

In an exemplary embodiment, the computing device 100 may determine the slope characteristics for the target device by a scheme of obtaining or measuring the performance of the target device for each of the workloads. The computing device 100 may determine the workload used for determining the slope characteristics in the set of selected (or predetermined) workloads by using the staircase performance characteristics granted to the target device. Based on the staircase performance characteristics of the target device, the computing device 100 may determine a first workload (e.g., a start workload) used to determine the slope characteristics of the target device by using the staircase performance characteristics of the target device. As described above, the computing device 100 may determine the characteristics corresponding to the target device by using the slope characteristics of the target device and the staircase performance characteristics of the target device. The staircase performance characteristics will be described below in FIG. 5.

In an exemplary embodiment, the computing device 100 may compare the characteristics of the target device and pre-stored characteristics of other devices. For example, the computing device 100 may express a performance change according to changes of workloads, which starts from the workload corresponding to the staircase performance characteristics of the target device as a line (i.e., slope characteristics) having a slope, with respect to the characteristics of the target device. The characteristics of the target device may be expressed as a form of including a plurality of slope characteristics. The computing device 100 may compare respective slope characteristics of respective target devices with slope characteristics of other devices, which represent slope characteristics of workloads corresponding to each other. The computing device 100 may repeatedly measure slope characteristics of at least two workloads for a set of selected (or predetermined) workloads when a new device is input, and determine whether slope characteristics in a set of performance predictors stored previously and the slope characteristics of the target device may correspond to each other in respective processes of repeatedly measuring the slope characteristics. For example, such a repeated measurement process may be performed for each of the subsets of N (N is a natural number) workloads acquired by splitting the set of selected (or predetermined) workloads randomly or evenly. When the characteristics of the newly input target device in each of the subsets of the workloads are enabled to be implemented by a combination (e.g., a linear combination) of the characteristics of other devices included in the performance predictors stored previously, the computing device 100 may generate the performance predictor of the target device through a combination (e.g., a linear combination) of performance predictors of other devices pre-stored. In an exemplary embodiment, a staircase interval of staircase performance characteristics of other devices used for the linear combination may have a multiple or submultiple relationship with a staircase interval of the staircase performance characteristics of the target device. For example, the multiple relationship or submultiple relationship may include an integer multiple or submultiple relationship. The set of selected (or predetermined) workloads in the present disclosure may mean a set of workloads considering staircase characteristics of the device.

In an exemplary embodiment, when determining that a combination (e.g., linear combination) relationship between characteristics of the target device for subsets of specific workloads and pre-stored characteristics of other devices is not established, the computing device 100 may add information corresponding to the performance of the corresponding target device to a performance predictor pool. The computing device 100 may determine whether the characteristics of the target device may be implemented by a combination of the characteristics of other devices using the same workload subset for each of a plurality of subsets. Since the technique according to an exemplary embodiment of the present disclosure may determine characteristics of a new device by using a combination of pre-stored characteristics of other devices by the above-described scheme, a performance predictor for the new device may be resource-efficiently determined. The technique according to an exemplary embodiment of the present disclosure may use the information previously stored in the performance predictor pool, before using all workloads in the set of selected (or predetermined) workloads, so when a new device is input, a new performance predictor corresponding to the new device may be generated by combining measurement results of the existing devices without performing resource consuming performance measurement (e.g., resource consuming latency measurement).

In an exemplary embodiment, the computing device 100 may efficiently generate the target performance predictor corresponding to the target device by using pre-stored information. In an exemplary embodiment, the computing device 100 may determine characteristics (e.g., a performance such as latency, etc.) of the target device corresponding to workloads not included in the set of selected (or predetermined) workloads without performing additional separate performance measurement. For example, the target performance predictor may include first characteristics of the target device corresponding to the workloads included in the set of selected (or predetermined) workloads, respectively and second characteristics of the target device corresponding to the workloads not included in the set of selected (or predetermined) workloads, respectively. Here, the second characteristics may be obtained by applying a linear interpolation method to the first characteristics. For example, the computing device 100 may obtain the second characteristics of the target device corresponding to the workloads not included in the set of selected (or predetermined) workloads, respectively, by applying linear interpolation to the first characteristics of the target device corresponding to the workloads included in the set of selected (or predetermined) workloads, respectively. The linear interpolation may be implemented by using at least one of linear interpolation or linear extrapolation. As a result, even when any workload not measured is input, the technique according to an exemplary embodiment of the present disclosure may allow performance prediction corresponding to the workload by the resource efficient scheme without performing additional separate performance measurement (e.g., latency measurement) for the workload. Performances or characteristics for workloads not used for performance measurement or characteristic determination may be included in the target performance predictor corresponding to the target device by using the above-described interpolation scheme.

In an exemplary embodiment, the computing device 100 may determine an estimated performance when the target model is executed in the target device based on a workload set and the target performance predictor (340).

In an exemplary embodiment, the estimated performance may include any type of information related to the performance estimated when the target model is executed in the target device. In an exemplary embodiment, the estimated performance may include a benchmark result. In an exemplary embodiment, the estimated performance may include a benchmark prediction result. In an exemplary embodiment, information included in the benchmark result or benchmark prediction result may include latency information. For example, the information included in the benchmark result or benchmark result information may include preprocessing time information consumed for preprocessing of interference of the target model in the target device, inference time information consumed for inferring the target model in the target device, preprocessing memory usage information used for preprocessing of the inference of the target model in the target device, and/or inferred memory usage information used for inferring the target model in the target device. For example, the information included in the benchmark result or benchmark prediction result may include quantitative information related to an inference time, which is obtained as the target model is inferred repeatedly a selected (or predetermined) number of times in the target device, and quantitative information related to memory use for an NPU, a CPU, and/or a GPU, which is obtained as the target model is inferred in the target device.

In an exemplary embodiment, the computing device 100 may determine the estimated performance of the target model for the target device based on performance information corresponding to each of the workloads. For example, latency prediction for the target model may be determined as a sum of latencies corresponding to workloads, respectively, after splitting the target model into workload units. For example, the computing device 100 may determine the estimated performance when the target model is executed in the target device based on a sum of sub estimated performances corresponding to a plurality of workloads included in the target workload set. Here, one workload may correspond to one sub estimated performance, and the sub estimated performances may be obtained from the target performance predictor.

In an exemplary embodiment, the computing device 100 applies a different estimated performance determination algorithm to each of the plurality of workloads included in the target workload set according to whether each of the plurality of workloads is included in the target performance predictor to determine the estimated performance when the target model is executed in the target device. For example, the computing device 100 may identify first workloads included in the target performance predictor among the plurality of workloads included in the target workload set, and second workloads not included in the target performance predictor among the plurality of workloads included in the target workload set. The computing device 100 may obtain first sub estimated performance corresponding to the first workloads from the target performance predictor, and determine second sub estimated performances corresponding to the second workloads based on the first sub estimated performance corresponding to the first workloads. The computing device 100 may determine the estimated performance when the target model is executed in the target device at least partially based on the first sub estimated performances and the second sub estimated performances.

In an exemplary embodiment, the computing device 100 may determine the second sub estimated performances corresponding to the second workloads by using a straight slope between the first sub estimated performances corresponding to the first workloads related to the second workloads (e.g., workloads related to the staircase performance characteristics of the device). Here, using the straight slope may include using interpolation (e.g., linear interpolation). For example, the linear interpolation may include at least one of linear interpolation or linear extrapolation.

As described above, the technique according to an exemplary embodiment of the present disclosure may use a latency of an operator in order to determine the characteristics of the device unlike technique that measure only the latency of the workload or operator with the device as a black box. Accordingly, the technique according to an exemplary embodiment of the present disclosure may measure latencies for the model and the device after determining the characteristics of the device which enables latency measurement of a more accurate and efficient scheme, compared to the method having the measurement of the latency of the operator itself as a purpose,

The technique according to an exemplary embodiment of the present disclosure may efficiently return the estimated performance (e.g., latency) related to the device based on the characteristics of the device in response to determining the characteristics of the device. According to the technique according to an exemplary embodiment of the present disclosure, a measurement requirement for the estimated performance is reduced, and even though a workload not measured is input, prediction corresponding to the workload is enabled without additional separate latency measurement, and when a new device is input, a new performance predictor corresponding to the new device may be generated by combining the characteristics of the existing devices without resource consuming latency measurement related to the device.

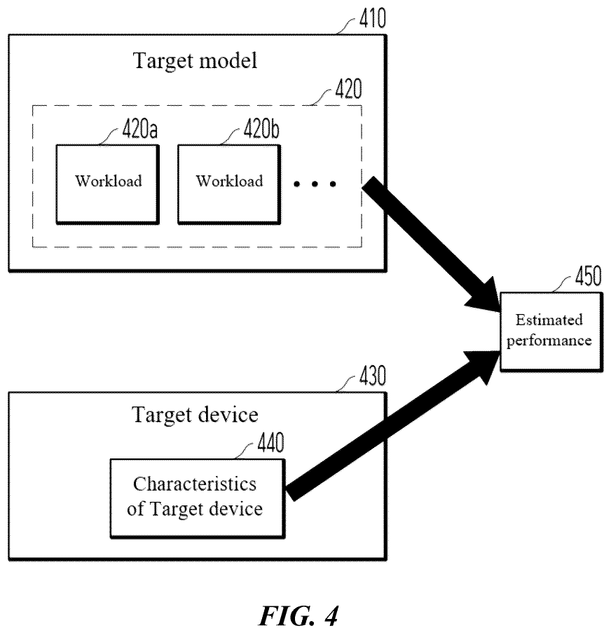

FIG. 4 exemplarily illustrates a method for providing an estimated performance of an artificial intelligence-based model considering device characteristics according to an exemplary embodiment of the present disclosure.

As illustrated in FIG. 4, the computing device 100 may extract, from a target model 410, workloads 420: 420a and 420b constituting the target model 410.

In an exemplary embodiment, the target model 410 may correspond to a model input from a user. The target model 410 may correspond to a model which becomes a target of performance measurement or performance prediction.

The performance measurement and the performance prediction in the present disclosure as a process of generating information related to the performance (e.g., latency) of the model may be used interchangeably with each other.

In an exemplary embodiment, the target model 410 may be split in units of workload 420. Through a set of the workloads 420, a computing volume and/or performance when the target model 410 operates may be determined. As an example, prediction for a latency of the target model 410 may be performed by using a latency for each of the workloads 420.

In an exemplary embodiment of the present disclosure, the workload 420 may be defined through the following equation.

$${W}_{a} = ( {x}_{a 0} , {x}_{a 1} , {x}_{a 1} , {x}_{a 2} … {x}_{an} ) , \qquad Equation 1$$

$${W}_{a} ∈ {R}^{n} = {\sum }_{i = 0}^{n} {x}_{ai} * \vec{{e}_{ι}}$$

Where W represents the workload, x represents a workload feature dimension, n represents numbers of workload feature dimensions, [symbol] represents a unit vector for each of the workload feature dimensions, and Rⁿ represents an n-dimensional real number vector space.

In an exemplary embodiment, the target device 430 may be used to refer to a device in which the target model 410 is to be executed. An estimated performance 450 may include performance information estimated when the target model 410 is executed in the target device 430. As a non-limited example, the performance information may include latency information.

In an exemplary embodiment, characteristics 440 of the target device for the target device 430 may be determined. The characteristics 440 of the target device may be determined by using sets of selected (or predetermined) workloads. Characteristics of each of a plurality of devices may be determined by using the sets of the selected (or predetermined) workloads. For example, since the characteristics of the plurality of devices may be determined by using a set of the same workloads, the characteristics of the device may be expressed as the estimated performance of the device for the workload. In an exemplary embodiment, the characteristics of the device may be determined a change rate of a performance according to a change in workload feature vector and staircase performance characteristics of each of the devices. As such, the characteristics of the device may be determined based on the workload of the model. Since the characteristics of the device may be used in a process of measuring or predicting the performance of the model, performance or performance prediction of the model considering the device is enabled.

In an exemplary embodiment, the characteristics 440 of the target device may include a combination of a plurality of sub characteristics. For example, slope characteristics representing performance changes of the device corresponding to a first workload and a second workload may be referred to as first sub characteristics, and slope characteristics representing performance changes of the device corresponding to a third workload and a fourth workload may be referred to as second sub characteristics.

In an exemplary embodiment, the characteristics 440 of the target device may include slope characteristics of the target device and staircase performance characteristics of the target device. The slope characteristics may represent a performance change rate of a device according to changes of the workloads. The staircase performance characteristics are staircase change characteristics of the performance of the target device, and the staircase performance characteristics may be used when determining workloads to be changed.

In an exemplary embodiment, the slope characteristics among the characteristics 440 of the target device may be defined through the following equation.

$$Equation 2$$

$$\begin{matrix}Char ( {W}_{a} , {W}_{b} ) = ( \frac{L ( {W}_{a} ) - L ( {W}_{b} )}{{x}_{a 0} - {x}_{b 0}} , \frac{L ( {W}_{a} ) - L ( {W}_{b} )}{{x}_{a 1} - {x}_{b 1}} , … \frac{L ( {W}_{a} ) - L ( {W}_{b} )}{{x}_{an} - {x}_{bn}} ) \\ = {\sum }_{i - 0}^{n} \frac{L ( {W}_{a} ) - L ( {W}_{b} )}{{x}_{ai} - {x}_{bi}} * \vec{{e}_{ι}} = {\sum }_{i - 0}^{n} \frac{Δ L ( {W}_{i} )}{Δ {x}_{i}} * \vec{{e}_{ι}}\end{matrix}$$

Where Char represents characteristics (e.g., slope characteristics) of a specific device having Wₐ and W_{b} as factors, Wₐ and W_{b} represent two workloads used to determine the slope characteristics, an L function represents a performance (e.g., latency) having Wₐ and/or W_{b} as the factor, [symbol] represents the unit vector for each of the workload feature dimension, and x represents the workload feature dimension.

In an exemplary embodiment, the characteristics 440 of the target device may be defined as in the following equation based on the slope characteristics and the staircase performance characteristics of the device.

$$Char ( D ) = \{ c \vert c = C har ( {W}_{α} , {W}_{β} ) \} \qquad Equation 3$$

Where Char (D) represents characteristics 440 of a device for a specific device, Wₐ and We represent workloads obtained from a set of workloads determined by reflecting staircase performance characteristics of the specific device, and Char (Wₐ, W_{β}) represents slope characteristics of the specific device having Wₐ and W_{β} as factors. Char (D) in Equation 3 may represent the slope characteristics of the specific device using the workloads obtained from the set of the workloads determined by reflecting the staircase performance characteristics of the specific device.

In an exemplary embodiment, the estimated performance 450 may be determined by using the characteristics 440 of the target device obtained based on the workload and the workloads 420 obtained from the target model 410.

In an exemplary embodiment, a workload set corresponding to an operation frequently used in an artificial intelligence based model may be prepared in advance. A set of workloads corresponding to an amount at a level to sufficiently determine the characteristics 440 of the target device may be prepared in advance for each operation.

In an exemplary embodiment, when the target device 430 corresponding to the new device is input, a performance slope of the device (e.g., the slope characteristics of the device) between two workloads in the set of the workloads prepared in advance may be repeatedly measured. Here, the measurement between two workloads may include performance measurement or performance comparison of the device corresponding to each of the two workloads. The performance measurement or performance comparison may be performed between network building blocks (e.g., residual blocks) having the same operation (e.g., Convolution, ReLU).

In an exemplary embodiment, when measurement of the characteristics 440 of the target device is completed by using the set of the selected (or predetermined) workloads, the performance (e.g., latency) for workloads not measured may be predicted by applying the linear interpolation method to information on the measured slope characteristics of the target device.

FIG. 5 exemplarily illustrates a relationship between a workload and a performance of a target device and a target model according to an exemplary embodiment of the present disclosure.

FIG. 5 exemplarily illustrates staircase performance characteristics 500 of a device. A performance (e.g., a Y axis in FIG. 5) (e.g., a latency value) according to workloads (values of the workloads) (e.g., a X axis in FIG. 5) of a target device and a target model are exemplarily illustrated in FIG. 5. For example, the X axis in FIG. 5 may represent a change (e.g., a change in workload) according to an output channel.

As illustrated in FIG. 5, the latency of the device may be represented as a staircase type according to workloads for a specific device. When a workload of an artificial intelligence model operates in most devices, a phenomenon in which the latency does not linearly increase for a specific dimension of the workload and latencies of a similar value or the same value are measured as one bundle during a specific interval 510 may be confirmed as in FIG. 5. Such a phenomenon may be referred to as a staircase latency, and the interval 510 herein may be referred to as a step.

In an exemplary embodiment, when workloads corresponding to staircase latency information are included in a set of selected (or predetermined) workloads during the specific interval, a non-linear performance measurement result may be derived in a process of analyzing the characteristics of the device. The technique according to an exemplary embodiment of the present disclosure may include a workload corresponding to a part 520 in which the staircase performance characteristics start in a set of workloads which become targets of analysis of device characteristics as in the example in FIG. 5 by using staircase performance characteristics predefined for a specific device. A set of latency slopes (e.g., slope characteristics of a device) for respective workloads in a set of workloads considering the staircase performance characteristics for the specific device may be referred to as characteristics for the specific device.

The set of selected (or predetermined) workloads in the present disclosure may correspond to a set of workloads considering staircase characteristics of the device. As such, the technique according to an exemplary embodiment of the present disclosure commonly uses the set of the workloads considering the staircase performance characteristics of the device to determine characteristics for respective devices by a resource efficient scheme.

In the present disclosure, a workload can be understood as a workload value. In this embodiment, a change in workload can be understood as a change in workload value.

In the present disclosure, a staircase performance is the step-like pattern of progress, where changes happen in distinct stages rather than gradually.

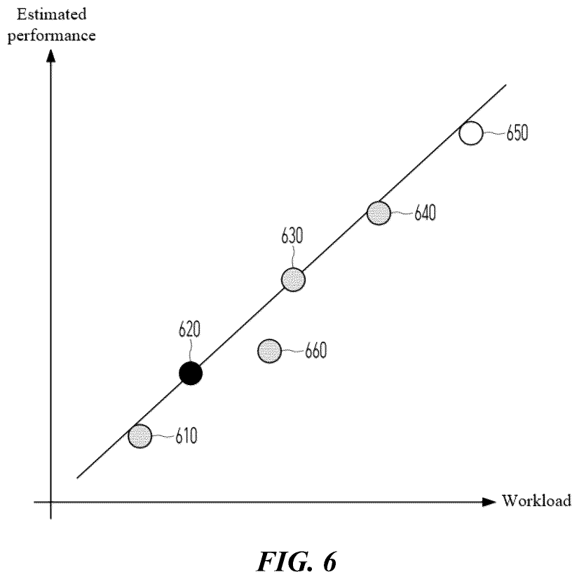

FIG. 6 exemplarily illustrates a methodology for interpolating the relationship between a workload and a performance (e.g., a latency) of a target device and a target model according to an exemplary embodiment of the present disclosure. For example, the X axis in FIG. 6 may represent a change (e.g., a change in workload) according to an input channel.

An example for the interpolation method used in the present disclosure may include the linear interpolation method. The linear interpolation method may include a method of linearly calculating information on a latency not measured according to a straight slope of the existing latencies. As a non-limited example, the linear interpolation method may include linear interpolation and linear extrapolation. For example, a prediction value of a performance change according to changes in workloads may be determined by using values corresponding to selected (or predetermined) workloads 610, 630, 640, and 660) (values of workloads) in FIG. 6. Estimated performances of other workloads 620 and 650 not measured may be determined based on a combination of the prediction values of the performance change.

A graph including the estimated performance according to the workload is illustrated in FIG. 6. The estimated performances 610, 660, 630, and 640 according to the workload may correspond to the existing obtained (for example, measured or predicted) values. The technique according to an exemplary embodiment of the present disclosure may determine an estimated performance corresponding to a workload (e.g., a workload not included in a set of selected (or predetermined) workloads) 620 not measured by using the values of the existing estimated performances 610 and 630 by using the linear interpolation. The technique according to an exemplary embodiment of the present disclosure may determine an estimated performance corresponding to a workload (e.g., a workload not included in a set of selected (or predetermined) workloads) 650 not measured by using the values of the existing estimated performances 630 and 640 by using the linear extrapolation.

In an exemplary embodiment, in the present disclosure, since an estimated performance corresponding to a workload which is not prepared may be determined by using estimated performances corresponding to existing other prepared workloads, resource efficient processing may be enabled when determining the characteristics of the device and/or estimating the performance of the model.

An interpolation technique according to an exemplary embodiment of the present disclosure may be used when determining the characteristics of the device, when generating the performance predictor for the device, and/or when determining the estimated performance of the model for the device. For example, when determining the characteristics of the device, the computing device 100 may determine characteristics of a device for other workloads other than the set of selected (or predetermined) workloads by using an interpolation method. For example, when generating the performance predictor corresponding to the device, the computing device 100 may determine performance predictors for other workloads other than the set of selected (or predetermined) workloads by using the interpolation method. For example, when determining the estimated performance of the model for the device, the computing device 100 may determine an estimated performance for a workload which is not obtained through the performance predictor by using the interpolation method.

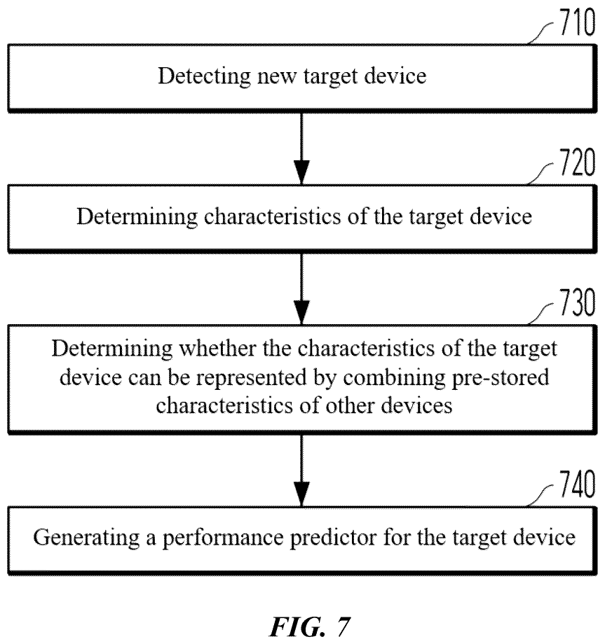

FIG. 7 exemplarily illustrates a methodology for generating a performance predictor for a target device according to an exemplary embodiment of the present disclosure.

According to an exemplary embodiment of the present disclosure, a computing device 100 may detect a new target device (710).

In an exemplary embodiment, the computing device 100 may obtain a request to confirm a performance for a target model. In an exemplary embodiment, the computing device 100 may obtain a request to confirm a performance for a target device for the target model. In an exemplary embodiment, the computing device 100 may obtain a request to add a new device into a pool of devices. In an exemplary embodiment, the computing device 100 may obtain a request to generate a performance predictor for the new device. The computing device 100 may determine or detect the new target device in response to the request.

In an exemplary embodiment, the computing device 100 may determine characteristics of the target device.

In an exemplary embodiment, the computing device 100 may determine the characteristics of the target device by using the methodologies illustrated in FIGS. 1 to 6. For example, the characteristics of the target device may be obtained based on performance measurement or performance prediction of the target device corresponding to selected (or predetermined) workloads. For example, the characteristics of the target device may be obtained based on the performance measurement or performance prediction of the target device corresponding to selected (or predetermined) workloads to which staircase performance characteristics of the target device are reflected. For example, the computing device 100 may determine the characteristics of the target device by repeatedly processing and/or confirming a set of the selected (or predetermined) workloads. An iterative procedure herein may be conducted in units of subsets of N (N is a natural number) workloads to which the set of the selected (or predetermined) workloads is evenly distributed. For example, the characteristics of the target device may include a slope performance of the target device measured by using the set of the workloads to which the staircase performance characteristics of the target device are reflected.

In an exemplary embodiment, the computing device 100 may determine whether the characteristics of the target device are enabled to be combined with pre-stored characteristics of other devices (730).

In an exemplary embodiment, the computing device 100 may generate a target performance predictor corresponding to the target device based on whether the characteristics of the target device are depending on the pre-stored characteristics of other devices. For example, the computing device 100 may determine whether the target device characteristics of the target device may be generated by a combination (e.g., a linear combination) of characteristics of devices of respective performance predictors included in a set of pre-stored performance predictors in the subsets of the workloads. Whether the characteristics of the target device may be expressed by the combination of the characteristics of other devices may be determined by using subsets of the same workloads. When determining whether the characteristics of the target device may be expressed by the combination of the characteristics of other devices, the computing device 100 may determine whether a condition in which staircase performance characteristics of the characteristics of other devices have a multiple or submultiple relationship with staircase performance characteristics of the characteristics of the target device is satisfied. Under the premise that the condition corresponding to the multiple or submultiple relationship is satisfied, the computing device 100 may determine whether the characteristics of the target device may be expressed by the combination of the characteristics of other devices.

In an exemplary embodiment, the computing device 100 may determine the characteristics of the target device by measuring a performance change of the target device in at least two workloads. The computing device 100 may obtain performance changes of other devices in the at least two workloads from the characteristics of other devices or performance predictors pre-stored, and determine whether to generate the performance change of the target device by combining the performance changes of other devices.

In an additional exemplary embodiment, the computing device 100 may also determine a performance predictor corresponding to the characteristics of another device as a target performance predictor when the characteristics of the target device and the characteristics of another device are matched with each other one to one.

In an exemplary embodiment, the computing device 100 may generate the performance predictor for the target device (740).

In an exemplary embodiment, the target performance predictor may mean a measured or calculated latency of the target device for the workload.

In an exemplary embodiment, the target performance predictor may mean a 2-dimensional data structure including first data representing the workload and second data representing the characteristics of the target device.

In an exemplary embodiment, when the characteristics (e.g., slope characteristics) of the target device measured for all subsets, respectively, in a set of selected (or predetermined) workloads, are not produced by a linear combination of the characteristics of other devices included in the set of performance predictors pre-stored, the computing device 100 may add a new element to the set of performance predictors pre-stored, and use an added element for producing the performance predictor in the future.

In an exemplary embodiment, the computing device 100 may calculate latencies corresponding to the workloads by using the linear interpolation method for the workloads in which the latency is not measured in the related art. The target performance predictor corresponding to the target device may be more efficiently generated through the linear interpolation method.

The technique according to an exemplary embodiment of the present disclosure confirms information on the set of performance predictors pre-stored in units of the subsets of the respective workloads before confirming all sets of selected (or predetermined) workloads to generate the target performance predictor corresponding to the target device by the resource efficient method.

When a performance predictor (e.g., latency predictor) of a new device is generated, performance measurement of the new device for all sets of selected (or predetermined) workloads is performed, so a load of work for measuring a performance of the new device for some of the sets of selected (or predetermined) workloads, and then generating the performance predictor corresponding to the new device through a linear combination of the performance predictors of other devices included in a pool of performance predictors stored in the related art may be smaller than a load of work for generating the performance predictor of the new device. As a result, the technique according to an exemplary embodiment of the present disclosure may achieve a technical effect of being capable of generating the performance predictor corresponding to the new device resource efficiently.

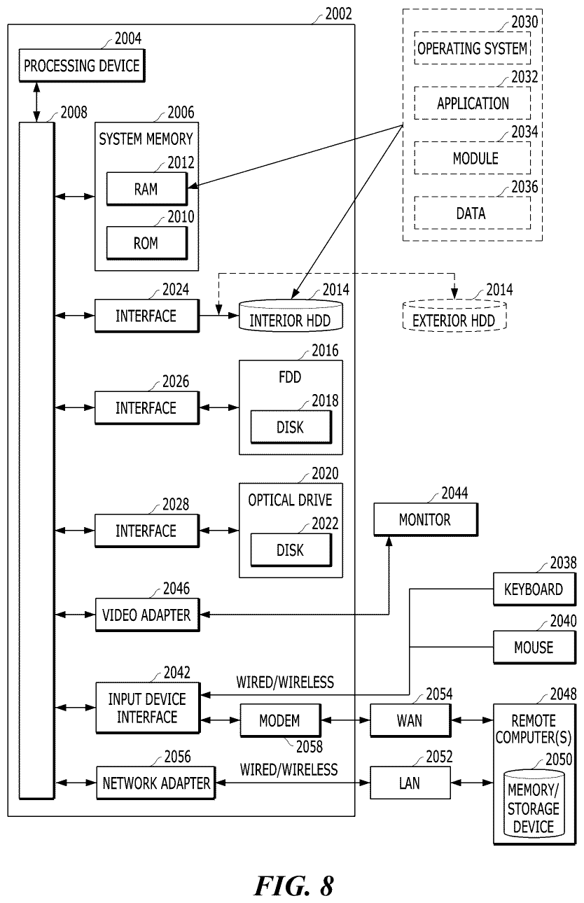

FIG. 8 is a schematic view of a computing environment of the computing device 100 according to an exemplary embodiment of the present disclosure.

In the present disclosure, the component, the module, or the unit includes a routine, a procedure, a program, a component, and a data structure that perform a specific task or implement a specific abstract data type. Further, it will be well appreciated by those skilled in the art that the methods presented by the present disclosure can be implemented by other computer system configurations including a personal computer, a handheld computing device, microprocessor-based or programmable home appliances, and others (the respective devices may operate in connection with one or more associated devices) as well as a single-processor or multi-processor computing device, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media.

The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 2000 that implements various aspects of the present disclosure including a computer 2002 is shown and the computer 2002 includes a processing device 2004, a system memory 2006, and a system bus 2008. The computer 200 in the present disclosure may be used intercompatibly with the computer device 100. The system bus 2008 connects system components including the system memory 2006 (not limited thereto) to the processing device 2004. The processing device 2004 may be a predetermined processor among various commercial processors. A dual processor and other multi-processor architectures may also be used as the processing device 2004.

The system bus 2008 may be any one of several types of bus structures which may be additionally interconnected to a local bus using any one of a memory bus, a peripheral device bus, and various commercial bus architectures. The system memory 2006 includes a read only memory (ROM) 2010 and a random access memory (RAM) 2012. A basic input/output system (BIOS) is stored in the non-volatile memories 2010 including the ROM, the EPROM, the EEPROM, and the like and the BIOS includes a basic routine that assists in transmitting information among components in the computer 2002 at a time such as in-starting. The RAM 2012 may also include a high-speed RAM including a static RAM for caching data, and the like.

The computer 2002 also includes an internal hard disk drive (HDD) 2014 (for example, EIDE and SATA), a magnetic floppy disk drive (FDD) 2016 (for example, for reading from or writing in a mobile diskette 2018), SSD and an optical disk drive 2020 (for example, for reading a CD-ROM disk 2022 or reading from or writing in other high-capacity optical media such as the DVD). The hard disk drive 2014, the magnetic disk drive 2016, and the optical disk drive 2020 may be connected to the system bus 2008 by a hard disk drive interface 2024, a magnetic disk drive interface 2026, and an optical drive interface 2028, respectively. An interface 2024 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 2002, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 2030, one or more application programs 2032, other program module 2034, and program data 2036 may be stored in the drive and the RAM 2012. All or some of the operating system, the application, the module, and/or the data may also be cached in the RAM 2012. It will be well appreciated that the present disclosure may be implemented in operating systems which are commercially usable or a combination of the operating systems.

A user may input instructions and information in the computer 2002 through one or more wired/wireless input devices, for example, pointing devices such as a keyboard 2038 and a mouse 2040. Other input devices (not illustrated) may include a microphone, an IR remote controller, a joystick, a game pad, a stylus pen, a touch screen, and others. These and other input devices are often connected to the processing device 2004 through an input device interface 2042 connected to the system bus 2008, but may be connected by other interfaces including a parallel port, an IEEE 1394 serial port, a game port, a USB port, an IR interface, and others.

A monitor 2044 or other types of display devices are also connected to the system bus 2008 through interfaces such as a video adapter 2046, and the like. In addition to the monitor 2044, the computer generally includes a speaker, a printer, and other peripheral output devices (not illustrated).

The computer 2002 may operate in a networked environment by using a logical connection to one or more remote computers including remote computer(s) 2048 through wired and/or wireless communication. The remote computer(s) 2048 may be a workstation, a server computer, a router, a personal computer, a portable computer, a micro-processor based entertainment apparatus, a peer device, or other general network nodes and generally includes multiple components or all of the components described with respect to the computer 2002, but only a memory storage device 2050 is illustrated for brief description. The illustrated logical connection includes a wired/wireless connection to a local area network (LAN) 2052 and/or a larger network, for example, a wide area network (WAN) 2054. The LAN and WAN networking environments are general environments in offices and companies and facilitate an enterprise-wide computer network such as Intranet, and all of them may be connected to a worldwide computer network, for example, the Internet.

When the computer 2002 is used in the LAN networking environment, the computer 2002 is connected to a local network 2052 through a wired and/or wireless communication network interface or an adapter 2056. The adapter 2056 may facilitate the wired or wireless communication to the LAN 2052 and the LAN 2052 also includes a wireless access point installed therein in order to communicate with the wireless adapter 2056. When the computer 2002 is used in the WAN networking environment, the computer 2002 may include a modem 2058, is connected to a communication server on the WAN 2054, or has other means that configure communication through the WAN 2054 such as the Internet, etc. The modem 2058 which may be an internal or external and wired or wireless device is connected to the system bus 2008 through the serial port interface 2042. In the networked environment, the program modules described with respect to the computer 2002 or some thereof may be stored in the remote memory/storage device 2050. It will be well known that an illustrated network connection is exemplary and other means configuring a communication link among computers may be used.

The computer 2002 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Method claims provide elements of various steps in a sample order, but the method claims are not limited to the presented specific order or hierarchical structure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for providing estimated performance of an artificial intelligence (AI)-based model considering characteristic of a device, performed by a computing device, comprising:
receiving at least one of an AI-based target model or target model information corresponding to the target model, and receiving target device information corresponding to a target device;
determining a target workload set including a plurality of workloads constituting the target model, based on at least one of the target model or the target model information;
extracting a target performance predictor corresponding to the target device, wherein the target performance predictor includes characteristic of the target device related to a workload; and
determining estimated performance when the target model is executed on the target device based on the target workload set and the target performance predictor; and
wherein the extracting the target performance predictor corresponding to the target device comprises:
determining whether the characteristic of the target device is dependent on pre-stored characteristics of other devices; and
when it is determined that the characteristic of the target device is dependent on the pre-stored characteristics of the other devices, generating the target performance predictor by using a combination of performance predictors corresponding to the other devices.

2. The method of claim 1, wherein the estimated performance includes latency information.

3. The method of claim 1, wherein each of the plurality of workloads is defined as an N-dimensional vector having N features that represent at least one of a function, an operation, or a structure of the target model, and N is a natural number.

4. The method of claim 1, wherein each of the plurality of workloads is determined based on at least one of a tilting parameter of a matrix multiplication, a connection relationship of an input and output tensors, an implementation mechanism of a deep learning runtime in which an operator is executed, an operator parameter, the number of MAC (Multiply-Accumulate) operations, an arithmetic intensity, a spatial size, the number of channels in a feature map and an operator type within the target model.

5. The method of claim 1, wherein the characteristic of the target device is determined based on changes in performance on the target device due to variations between workloads or variations in a feature of a workload.

6. The method of claim 5, wherein the characteristic of the target device is determined further based on a staircase performance characteristic, wherein the staircase performance characteristic is used to determine a start workload in variations between workloads.

7. The method of claim 1, wherein the characteristic of the target device is determined based on changes in performance on the target device due to variations between workloads,
wherein the changes in performance on the target device include a first change in performance on the target device due to variations between a first set of workloads within pre-determined set of workloads, and a second change in performance on the target device due to variations between a second set of workloads within the pre-determined set of workloads, and
wherein a first start workload corresponding to a start point of the first set of workloads and a second start workload corresponding to a start point of the second set of workloads are determined based on a staircase performance characteristic.

8. The method of claim 1, wherein the target performance predictor is a two-dimensional data structure that includes first data representing a workload and second data representing the characteristic of the target device.

9. The method of claim 1, wherein the extracting the target performance predictor corresponding to the target device comprises:
extracting a plurality of sub-characteristics of the target device, based on measuring changes in performance of the target device between at least two workloads within a set of selected workloads multiple times across the set of selected workloads, wherein one sub-characteristic of the target device for at least two workloads is extracted by a single measurement;
determining whether at least one of the plurality of sub-characteristics of the target device can be represented as a linear combination of pre-stored sub-characteristics of other devices; and
generating the target performance predictor as a combination of performance predictors corresponding to the other devices, when it is determined that the at least one sub-characteristic of the target device can be represented as the linear combination of the pre-stored sub-characteristics of the other devices.

10. The method of claim 9, wherein second staircase characteristics of characteristics of the other devices have a multiple relationship or divisor relationship with a first staircase characteristic of characteristics of the target device.

11. The method of claim 9, wherein the performance predictors corresponding to the other devices are pre-stored in a performance predictor pool,
wherein one performance predictor is mapped to one device in the performance predictor pool, and
wherein the extracting the target performance predictor corresponding to the target device comprises, when it is determined that the sub-characteristic of the target device cannot be represented as the linear combination of the pre-stored sub-characteristics of the other devices, adding the target device or the sub-characteristic of the target device to the performance predictor pool.

12. The method of claim 1, wherein the target performance predictor includes a first characteristic of the target device, corresponding to each of workloads included in a set of pre-determined workloads, and a second characteristic of the target device, corresponding to each of workloads which are not included in the set of the pre-determined workloads, and wherein the second characteristic is extracted by applying linear interpolation to the first characteristic.

13. The method of claim 1, wherein the determining the estimated performance comprises determining the estimated performance when the target model is executed on the target device based on a sum of sub-estimated performances corresponding to the plurality of workloads included in the target workload set, wherein one workload corresponds to one sub-estimated performance and the sub-estimated performances are extracted from the target performance predictor.

14. The method of claim 1, wherein the determining the estimated performance comprises determining the estimated performance when the target model is executed on the target device by applying different estimated performance determination algorithms to each of the plurality of workloads included in the target workload set, based on whether the each of the plurality of workloads included in the target workload set is included in the target performance predictor.

15. The method of claim 1, wherein the determining the estimated performance comprises:
identifying first workloads which are included in the target performance predictor among the plurality of workloads included in the target workload set and second workloads which are not included in the target performance predictor among the plurality of workloads included in the target workload set;
extracting first sub-estimated performances corresponding to the first workloads from the target performance predictor, and determining second sub-estimated performances corresponding to the second workloads based on first sub-estimated performances corresponding to the first workloads; and
determining the estimated performance when the target model is executed on the target device based at least partially on the first sub-estimated performances and the second sub-estimated performances.

16. The method of claim 15, wherein the determining the second sub-estimated performances comprises determining second sub-estimated performances corresponding to the second workloads by using a linear slope between first sub-estimated performances corresponding to the first workloads related to the second workloads.

17. The method of claim 15, wherein the determining the second sub-estimated performances uses at least one of a linear interpolation or a linear extrapolation.

18. A computer program stored in a non-transitory computer readable storage medium, wherein the computer program allows a computing device to perform following operations to provide estimated performance of an artificial intelligence (AI)-based model considering characteristic of a device, and wherein the operations comprise:
receiving at least one of an AI-based target model or target model information corresponding to the target model, and receiving target device information corresponding to a target device;
determining a target workload set including a plurality of workloads constituting the target model, based on at least one of the target model or the target model information;
extracting a target performance predictor corresponding to the target device, wherein the target performance predictor includes characteristic of the target device related to a workload; and
determining estimated performance when the target model is executed on the target device based on the target workload set and the target performance predictor; and
wherein the extracting the target performance predictor corresponding to the target device comprises:
determining whether the characteristic of the target device is dependent on pre-stored characteristics of other devices; and
when it is determined that the characteristic of the target device is dependent on the pre-stored characteristics of the other devices, generating the target performance predictor by using a combination of performance predictors corresponding to the other devices.

19. A computing device for providing estimated performance of an artificial intelligence (AI)-based model considering characteristic of a device, comprising:
at least one processor; and
a memory,
wherein the at least one processor:
receives at least one of an AI-based target model or target model information corresponding to the target model, and receives target device information corresponding to a target device;
determines a target workload set including a plurality of workloads constituting the target model, based on at least one of the target model or the target model information;
extracts a target performance predictor corresponding to the target device, wherein the target performance predictor includes characteristic of the target device related to a workload; and
determines estimated performance when the target model is executed on the target device based on the target workload set and the target performance predictor; and
wherein the extracting the target performance predictor corresponding to the target device comprises:
determining whether the characteristic of the target device is dependent on pre-stored characteristics of other devices; and
when it is determined that the characteristic of the target device is dependent on the pre-stored characteristics of the other devices, generating the target performance predictor by using a combination of performance predictors corresponding to the other devices.
